(19) United States
(12) Patent Application Publication
(10) Pub. No.: US 2021/0001894 A1
(43) Pub. Date: Jan. 7, 2021

(54) METHOD FOR EXECUTING AN AUTONOMOUS DRIVING OPERATION IN A VEHICLE

(71) Applicant: Robert Bosch GmbH, Stuttgart (DE)

(72) Inventor: Dirk Mahnkopf, Eglosheim (DE)

(21) Appl. No.: 16/909,483

(22) Filed: Jun. 23, 2020

(30) Foreign Application Priority Data
Jul. 6, 2019 (DE) 102019209971.8

(51) Int. Cl. B60W 60/00; B60W 40/09

(52) U.S. Cl. CPC B60W 60/0059; B60W 2040/0809; B60W 40/09; B60W 60/0018

(57) ABSTRACT

In a method for executing an autonomous driving operation in a vehicle, for the case in which a driving action influencing the driving dynamics takes place without authorization, the action is canceled.

### CROSS REFERENCE

The present application claims the benefit under 35 U.S.C. § 119 of German Patent Application No. DE 102019209971.8 filed on Jul. 6, 2019, which is expressly incorporated herein by reference in its entirety.

### FIELD

The present invention relates to a method for executing an autonomous driving operation in a vehicle.

### BACKGROUND INFORMATION

A method, related to a commercial vehicle, for surrendering autonomous driving to manual driving is described in PCT Application No. WO 2018/046253 A1. During the surrender, it is checked if the driver is authorized to stay in the commercial vehicle and to execute driving activities there. If this is the case and the driver additionally manipulates the brake pedal and operates a disconnecting switch, then the desired surrender from autonomous to manual driving takes place.

An assistance system for a vehicle, which allows autonomous operation of the brake system, is described in German Patent Application No. DE 11 2016 004 141 T5. For the case in which the brake pedal is inadvertently blocked by the foot of the driver, the assistance system also allows a braking action executed autonomously.

### SUMMARY

Using an example method of the present invention, an autonomous driving operation may be executed in a vehicle. In this connection, for the case, in which a personal driving action of a person in the vehicle takes place during the autonomously executed driving operation, where the personal driving action influences the handling or the driving dynamics of the vehicle, this personal driving action is canceled, if the person in question does not have driving authorization.

This procedure may have the advantage that the driving safety in autonomously driven vehicles may be improved significantly. Therefore, during an autonomously executed driving operation, each manual action upon the vehicle, which has an effect on the handling or the driving dynamics, is under the condition of driving authorization of the person, who carries out the action. If the driving authorization is present, then the personal driving action may be carried out, which means that the autonomous driving operation is influenced and possibly interrupted. However, if the person executing the driving action does not have driving authorization, then the corresponding personal driving action is canceled.

The cancellation of the personal driving action advantageously includes both the situation, that a driver actuation unit activated by the personal driving action is rendered inactive, and, advantageously, the situation, that the activated driver actuation unit is locked. However, in an alternative variant, it may also be sufficient for only the activated driver actuation unit to be rendered inactive, or for only the activated driver actuation unit to be locked.

The method preferably relates to the driver, that is, to the person in the driver's seat, whose driving authorization is being checked. However, the method may also additionally relate to further persons in the vehicle, for example, a person in the front passenger seat or in the back seat, who executes a personal driving action intentionally or unintentionally in the vehicle, such as gripping the steering wheel or manipulating the hand brake. This case is also covered by the method of the present invention, since it is determined that the person not in the driver's seat does not have a current driving authorization, whereupon the driving action executed by this person is canceled. It is possible for only the driving authorization of the driver to be checked or, in an alternative variant, both the driving authorization of the driver and the driving authorization or intervention authorization of a person in the vehicle, who is not sitting in the driver's seat.

The driver actuation unit, which is optionally manipulated by the person in the vehicle, influences the handling or the driving dynamics of the vehicle. In particular, the longitudinal dynamics and/or the lateral dynamics of the vehicle are influenced by the driver actuation unit. The driver actuation unit is, in particular, a pedal in the vehicle, preferably, the brake pedal. However, other driver actuation units are also considered, such as the accelerator pedal or the steering wheel. Above and beyond that, further driver actuation units, which are activated by the person in the vehicle, are possibly considered, such as the hand brake or parking brake.

The example method is advantageously executed only in the case of a completely autonomous driving operation, in which braking, acceleration and steering are carried out automatically without action by the driver. In this situation, a personal driving action is canceled, if the driving authorization is absent.

Therefore, the autonomous driving operation is executed in spite of the personal driving action.

In the case of an only semiautonomous driving operation, it may also be useful, in some instances, to cancel a personal driving action, if a driving authorization of the person in question is not present. This concerns, for example, personal driving actions, which are not carried out by a person in the driver's seat, for example, by the front-seat passenger, while the vehicle is in the semiautonomous driving state, in which driving is done partially autonomously and partially manually. Such driving states relate to, for example, so-called level-1 conditions, including automatic braking and acceleration events, but steering actions by the driver.

According to a further advantageous variant of the present invention, a warning signal is generated in the vehicle, if a personal driving action takes place and the personal driving action is canceled due to a missing driving authorization. The warning signal may be generated and indicated to the driver in different ways. For example, it may be useful to indicate the warning signal acoustically, optically or haptically in the vehicle. Additionally, or as an alternative, it is also possible to generate a warning signal by automatically intervening in the driving dynamics of the vehicle, for example, using an automatic braking action, an automatic acceleration action, or an automatic steering action. In this connection, for example, a brief pulse for braking, accelerating or steering may be generated several times in succession; the pulse being able to be registered by the driver. Additionally, or as an alternative, it is also possible to influence a driver actuation unit in the vehicle without, or at least without considerable, intervention in the driving dynamics of the vehicle, in such a manner, that the influence is perceived by the driver, for example, via a change in the pedal characteristic or a change in the restoring steering force.

According to a further advantageous variant of the present invention, the driving authorization is ascertained prior to the start of a trip and/or during the trip. For example, driver identification may be carried out, in particular, in light of features specific to persons, such as fingerprints or the like, or using an identification document. This ensures that, in principle, only persons, who possess a valid driver's license, are authorized for a driving action. This driver identification is carried out, in particular, prior to the start of a trip.

In addition, or as an alternative, it is also possible to perform an authorization of the personal driving action during the trip. This is accomplished, in particular, with the aid of sensor signals, which are ascertained and evaluated in the vehicle by a vehicle sensor system. For example, due to the driving behavior that the driver showed prior to the bringing into force of the autonomously executed driving operation, an increased state of fatigue of the driver may be established. For example, in light of the driving behavior, it is also possible to deduce excessive intake of substances, for example, the intake of alcohol, which negatively affect driving behavior. In these cases, to be sure, it may be indicated that the vehicle is being driven completely autonomously, but that a personal driving action, e.g., for assuming manual driving from autonomous, is canceled for reasons of safety.

In addition, using sensor signals, it is also possible to determine if a person, who is not the driver, is executing an unauthorized driving action. This is accomplished, for example, by a sensor system for monitoring the passenger compartment.

According to a further advantageous variant of the present invention, which relates to a personal driving action upon a brake pedal in a vehicle, the brake pedal is disconnected hydraulically from the wheel brakes of the vehicle brake, in order to cancel the personal driving action upon the brake pedal. The hydraulic disconnection is preferably carried out by adjusting valves in the hydraulic brake circuit, for example, by closing an intake valve. In this case, the hydraulic disconnection is carried out either between the brake pedal and a brake booster, in particular, a hydraulic brake cylinder, or between the brake booster and the wheel brakes in the vehicle.

According to one advantageous variant, which relates to a brake pedal as a driver actuation unit, during an autonomous braking action, the personal driving action is accepted until the brake pressure requested by the autonomous braking action is reached. Only beyond that, is a further braking request by the driver canceled. This procedure does not have an effect on the driving dynamics of the vehicle, since the brake-pressure request by the driver is only implemented until the brake pressure autonomously requested is attained. An inlet pressure sensor, by which the brake-pressure request by the driver is ascertainable, is situated in the hydraulic brake system.

During the manipulation of the brake pedal by the driver, after the brake-pressure limit specified by the autonomous system is reached, it may be useful to convey brake fluid from the wheel brakes, either into an equalizing reservoir in the hydraulic brake circuit or into the hydraulic cylinder.

If, after the brake-pressure limit specified by the autonomous system is reached, brake pressure is additionally built up via driver actuation, and volume is displaced into the wheel brakes due to a possible latency time, it may be useful to transport this hydraulic volume back into the equalizing reservoir or the brake-pressure cylinder.

According to a further advantageous variant of the present invention, in order to generate a warning signal, it may be useful to allow a short-term build-up of pressure by opening intake valves in the hydraulic brake circuit, while the driver manipulates the brake pedal, even if no driving authorization is present. Due to the short-term build-up of pressure, the vehicle is temporarily decelerated in a corresponding manner, which is perceived by the driver and may be interpreted as a warning signal. A build-up of pressure, which differs from the pressure build-up that would be generated via manipulation of the pedal by the driver, is advantageously produced. For example, it may be useful to produce a higher build-up of pressure only temporarily, or to allow a build-up of pressure to take place with a time delay.

According to a further advantageous variant of the present invention, which likewise relates to a warning signal that is generated if a personal driving action takes place without a driving authorization, in response to unauthorized manipulation of the brake pedal, a volumetric flow of hydraulic fluid is temporarily allowed, by opening intake valves in a correspondingly brief and controlled manner, in order to permit movement of the pedal. Subsequently, the brake fluid may be conveyed back, in order to modulate the restoring force in the brake pedal and, through this, to warn the driver. In addition, it is possible to modulate the brake pressure autonomously, in order to adjust a correspondingly altered deceleration and/or a corresponding restoring force in the brake pedal.

In some instances, the modulation of braking force and/or restoring force in the brake pedal is repeated several times, in order to generate a clearly perceptible warning signal. Furthermore, it is possible for the input power of the vehicle to be influenced automatically, in particular, in a manner that compensates for the brake pressure, in order to keep the vehicle speed at a setpoint speed.

The brake system is a hydraulic brake system, which is equipped, in particular, with an additional ESP system (electronic stability program) that includes a hydraulic ESP pump in the hydraulic circuit. In such a brake system, the method described above may be implemented exclusively via software control.

The present invention also relates to a control unit for executing the method described above. The different method steps proceed in the control unit, in which actuating signals are generated for executing the autonomous driving operation via control of the vehicle brake, drive motor and/or steering system in the vehicle. In the control unit, it is checked if a personal driving action executed without driving authorization is present; in this case, the personal driving action being canceled. Accordingly, a driver actuation unit, which is activated by the personal driving action, may be rendered inactive by the control unit, in that, e.g., in the case of a brake pedal, the valves in the brake circuit are opened or closed.

Finally, the present invention also relates to a vehicle having a corresponding control unit and a driver actuation unit, which is controllable via the control unit.

Furthermore, the present invention also relates to a computer program product including program code, which is designed to execute the method steps described above. The computer program product runs in the control unit described above.

Further advantages and useful embodiments may be gathered from the description herein and the figures.

### BRIEF DESCRIPTION OF THE DRAWINGS

FIG. 1 shows a hydraulic circuit diagram of a vehicle brake system.

FIG. 2 shows a flow chart including example method steps for executing an autonomous driving operation in a vehicle in accordance with the present invention.

### DETAILED DESCRIPTION OF EXAMPLE EMBODIMENTS

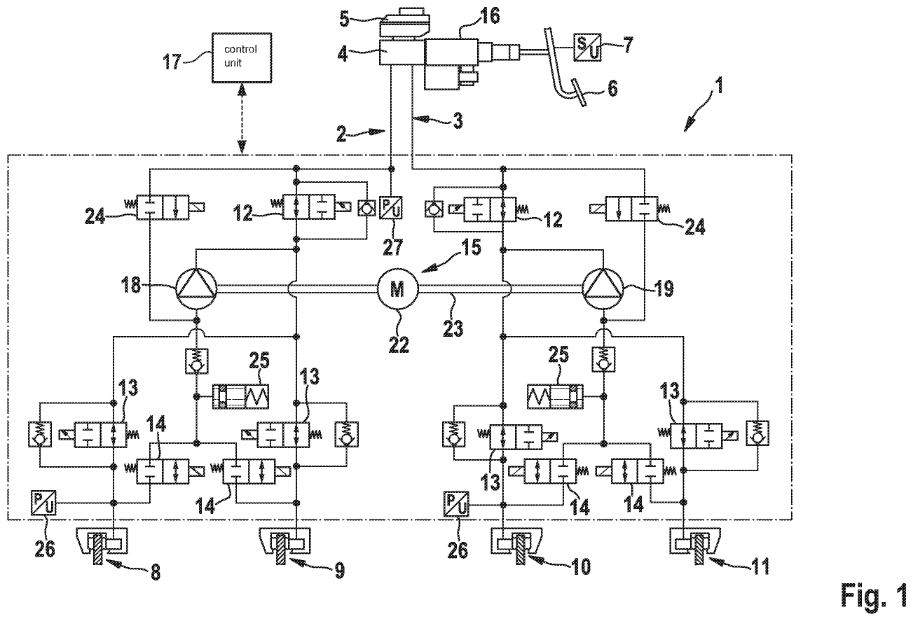

The hydraulic brake system 1 in a vehicle, represented in the hydraulic circuit diagram shown in FIG. 1, includes two brake circuits 2 and 3 positioned crosswise. First brake circuit 2 takes the form of a front-axle brake circuit, and second brake circuit 3 takes the form of a rear-axle brake circuit. Brake circuits 2, 3 are used for supplying hydraulic brake fluid to wheel brake units 8, 9 at the left front and right front wheels, respectively, as well as to wheel brake units 10 and 11 at the left rear and right rear wheels, respectively.

Alternatively, a diagonal division of brake circuits 2 and 3 is considered, in which wheel brake units 8 and 9 are positioned at the left front and right rear wheels and wheel brake units 10 and 11 are positioned at the right front and left rear wheels.

The two brake circuits 2, 3 are connected to a common master brake cylinder 4, which is supplied with brake fluid by a brake fluid reservoir 5. Master brake cylinder 4 is actuated by the driver via brake pedal 6. The pedal travel effected by the driver is measured by a pedal travel sensor 7. An electrically operable brake booster (iBooster) 16, which includes, for example, an electric motor that preferably actuates master brake cylinder 4 via a gear unit, is situated between brake pedal 6 and master brake cylinder 4.

A switchover valve 12 is positioned in each brake circuit 2, 3; the switchover valve being situated in the flow route between the master brake cylinder and respective wheel brake units 8, 9 and 10, 11. In their de-energized, initial state, switchover valves 12 are open. Each switchover valve 12 is assigned a parallelly connected check valve, which may be traversed by flow in the direction of the respective wheel brake units.

Intake valves 13 are situated between switchover valves 12 and respective wheel brake units 8, 9 and 10, 11; the intake valves being assigned check valves, which are traversable by flow in the reverse direction, that is, from the wheel brake units, in the direction of the master brake cylinder. The intake valves 13 at the front wheels of the vehicle are open when de-energized. The intake valves 13 at the rear wheels of the vehicle are closed in the de-energized state, but they are shifted into the open position with the exceedance of a defined differential pressure (closed at zero current as a function of the differential pressure).

Each wheel brake unit 8, 9 and 10, 11 is assigned a respective exhaust valve 14, which is closed when de-energized. Exhaust valves 14 are each connected to the suction side of a pump unit 15, which includes a pump 18, 19 in each brake circuit 2, 3, respectively. The pump unit is assigned a common electrical drive motor or pump motor 22, which operates the two pumps 18, 19 via a shaft 23. The pressure side of pump 18, 19 is connected, in each instance, to a section of line between switchover valve 12 and the two intake valves 13 per brake circuit.

The suction sides of pumps 18 and 19 are each connected to a main or high-pressure control valve 24, which is hydraulically connected to master brake cylinder 4. In a driving-dynamics control action, the main control valves 24 closed in the de-energized state may be opened for a rapid build-up of brake pressure, which means that pumps 18 and 19 draw in hydraulic fluid directly from master brake cylinder 4. This build-up of brake pressure may be implemented independently of actuation of the brake system by the driver. The pump unit 15 including the two individual pumps 18 and 19, electric pump motor 22 and shaft 23 may belong to a driver assistance system and forms an electronic stability program (ESP system), which is activated, in particular, to stabilize the vehicle.

For each brake circuit 2, 3, a hydraulic reservoir 25, which is used for temporarily storing brake fluid that is released from wheel brake units 8, 9 and 10, 11 by exhaust valves 14 during a driving dynamics action, is situated between exhaust valves 14 and the suction side of pumps 18 and 19. Each hydraulic reservoir 25 is assigned a check valve, which opens into the direction of the suction sides of pumps 18, 19.

A pressure sensor 26 for measuring pressure is positioned in each brake circuit 2, 3 in, in each instance, the region of wheel brake units 8, 9 and 10, 11. A further pressure sensor 27 is positioned in brake circuit 2, adjacent to master brake cylinder 4.

The ESP system having pump unit 15 forms a brake actuator system for generating hydraulic brake pressure independently of the driver in the wheel brake units in the two brake circuits 2, 3. The ESP system is used for stabilizing the vehicle, by controlling different valves in the brake system, as well as pumps 18, 19, in such a manner, that locking of the vehicle wheels is prevented.

Brake system 1 is also assigned a control unit 17, in which sensor signals are processed and actuating signals for controlling active units, such as the brake booster, the valves, and the pumps of the ESP system, are generated.

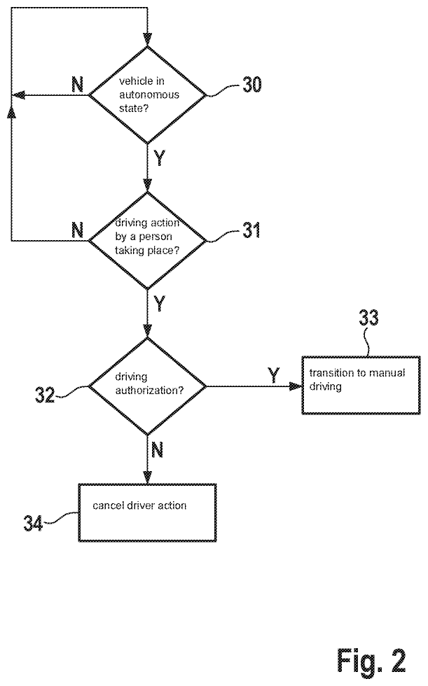

In FIG. 2, a flow chart including example method steps for executing an autonomous driving operation in a vehicle is shown for the case, in which the driver or an additional person in the vehicle executes a driving action.

In a first method step 30, it is initially checked if the vehicle is in an autonomous driving state, in which, in particular, the vehicle is controlled completely autonomously, using automatic braking, acceleration and steering actions. If this is not the case, then the No-branch (“N”) is subsequently returned again to the start of the inquiry in step 30, and the inquiry is run through repeatedly in cyclical intervals.

On the other hand, if the vehicle is in an autonomous driving state, the Yes-branch (“Y”) is subsequently advanced to the next method step 31, in which the inquiry is made as to whether a driving action by a person in the vehicle is currently taking place. This driving action is, in particular, manipulation of the brake pedal by the driver. Other driving actions are also considered, in particular, manipulation of the accelerator pedal and manipulation of the steering wheel.

If such a driving action is not occurring, the No-branch is subsequently returned again to the start of the entire method, which is run through repeatedly in cyclical intervals, starting at step 30. However, if such a driving action is occurring, the Y-branch is subsequently advanced to the next step 32.

In step 32, it is checked if the driving action from step 31 has occurred with driving authorization. The authorization may take place, for example, by identifying the driver prior to the start of a trip, for example, by checking the driver's license or another proof of identity. In addition, or as an alternative, it is also possible, using a sensor system, to check the current driving authorization of the driver in the vehicle, in particular, with regard to a high state of fatigue or with regard to the intake of substances impairing the ability to drive. For example, this is accomplished in that state variables measured by sensors are evaluated from previous or current manipulation of a driver actuation unit in the vehicle, for example, from steering movements. In addition, or alternatively, it is also possible to check head movements or eye movements of the driver, using cameras, and to check them with regard to conformity with a reference pattern, which allows inability of the driver to drive or at least reduced ability of the driver to drive to be deduced.

If, in step 32, the check reveals that the driver acted with driving authorization, then the Yes-branch is subsequently advanced to step 33. In this case, it is typically the transition from autonomous to manual driving, whereupon the autonomous driving is ended and the responsibility for the driving passes over to the driver. In this case, the method according to FIG. 2 is ended.

However, if the inquiry in step 32 reveals that the driver executed the action without driving authorization, then the No-branch is subsequently advanced to step 34 and the action of the driver is canceled. This is accomplished either by rendering the activation of a driver actuation unit generated by the driver inactive, or by locking the driver actuation unit. If, for example, the driver manipulated, or is about to manipulate, the brake pedal, then the brake pedal movement may either be blocked or be allowed without blockage, but hydraulically disconnected from the brake system, so that the brake pedal movement does not have any effect on the current generation of brake force.

If a braking action is currently being executed in the autonomous driving state, then the brake pedal movement generated by the driver may possibly be utilized for generating brake pressure, until the brake pressure level specified by the autonomous system is reached. Above and beyond that, a brake pedal movement initiated by the driver is put into force.

The method is also suited for neutralizing an unauthorized driving action by a front-seat passenger or passenger in the vehicle. Using the sensor system in the vehicle, it may be determined that a possible driving action is being initiated by a front-seat passenger or passenger, whereupon this driving action is canceled.

What is claimed is:

1. A method for executing an autonomous driving operation in a vehicle, comprising:
detecting, during the autonomous driving operating, a personal driving action influencing handling or driving dynamics taking place without driving authorization; and
based on the detecting, canceling the personal driving action.

2. The method as recited in claim 1, wherein during the cancellation of a personal driving action, an activated driver actuation unit is rendered inactive.

3. The method as recited in claim 1, wherein during the cancellation of a personal driving action, an activated driver actuation unit is locked.

4. The method as recited in claim 2, wherein the driver actuation unit is a brake pedal in the vehicle.

5. The method as recited in claim 4, wherein the brake pedal is hydraulically disconnected from the wheel brakes to cancel the personal driving action upon the brake pedal.

6. The method as recited in claim 1, wherein the driving operation is executed completely autonomously, using automatic braking, acceleration and steering actions.

7. The method as recited in claim 1, wherein a warning signal is generated when the personal driving action is canceled.

8. The method as recited in claim 1, wherein a warning signal is generated by modulating brake pressure in a vehicle brake, when the personal driving action is canceled.

9. The method as recited in claim 1, wherein the driving authorization is ascertained during a trip by evaluating sensor signals.

10. The method as recited in claim 1, wherein the driving authorization is ascertained prior to a start of a trip, by evaluating sensor signals or by identifying a driver.

11. The method as recited in claim 1, wherein the authorization for the personal driving action is ascertained during a trip, by evaluating sensor signals.

12. A control unit for controlling a driver actuation unit of a vehicle, the control unit configured to:
detect, during the autonomous driving operating, a personal driving action influencing handling or driving dynamics taking place without driving authorization; and
based on the detection, cancel the personal driving action.

13. A vehicle, comprising:
a control unit; and
a driver actuation unit that influences handling or driving dynamics of the vehicle;
wherein the control unit is configured to:
detect, during the autonomous driving operating,
a personal driving action influencing handling or driving dynamics taking place without driving authorization; and
based on the detection, cancel the personal driving action.

14. A non-transitory computer-readable memory medium on which is stored a computer program having program code for executing an autonomous driving operation in a vehicle, the computer program, when executed by a computer, causing the computer to perform:
detecting, during the autonomous driving operating, a personal driving action influencing handling or driving dynamics taking place without driving authorization; and
based on the detecting, canceling the personal driving action.
